(19) United States
(12) Patent Application Publication
(10) Pub. No.: US 2016/0048653 A1
(43) Pub. Date: Feb. 18, 2016

(54) USER EQUIPMENT, SERVICE PROVIDING DEVICE, CONTROL METHOD THEREOF AND COMPUTER READABLE MEDIUM HAVING COMPUTER PROGRAM RECORDED THEREOF

(71) Applicant: SK PLANET CO., LTD., GYEONGGI-DO (KR)

(72) Inventors: Jin Ho KANG, SEOUL (KR); Sil Keun HWANG, Gyeongsangnam-do (KR); Moon Suk CHO, SEOUL (KR); Keun Ho CHOI, SEOUL (KR)

(73) Assignee: SK PLANET CO., LTD., GYEONGGI-DO (KR)

(21) Appl. No.: 14/822,219

(22) Filed: Aug. 10, 2015

(30) Foreign Application Priority Data
Aug. 13, 2014 (KR) 10-2014-0105042
Aug. 13, 2014 (KR) 10-2014-0105043
Aug. 13, 2014 (KR) 10-2014-0105044

(51) Int. Cl. G06F 19/00; H04N 7/18

(52) U.S. Cl. CPC G06F 19/3418; H04N 7/18; H04N 7/181

(57) ABSTRACT

The present invention provides user equipment, a method of controlling the user equipment, and a recording medium having a computer program. That is, the present invention makes infants actively check their attending and leaving by arousing their interest in order to sense their attending/leaving through NFC tagging, lets their parents know it in real time, and outputs greeting messages set for each infant on the basis of attending/leaving management data for infants and medical data of infants, so it can improve convenience of use. Further, the present invention provides a user with a list of actually available hospitals in consideration of time to be taken to reach hospitals and to register in the hospitals and provides information about the closest hospital in the available hospitals, thereby improving convenience in used.

### CROSS-REFERENCE TO RELATED APPLICATION

This application claims the benefit of Korean Application Nos. 10-2014-0105042 filed on Aug. 13, 2014, 10-2014-0105043 filed on Aug. 13, 2014 and 10-2014-0105044 filed on Aug. 13, 2014 with the Korean Intellectual Property Office, the disclosure of which is incorporated herein by reference.

### BACKGROUND OF THE INVENTION

1. Field of the Invention

The present invention relates to user equipment, a service providing device, a control method thereof, and a computer readable medium having computer program recorded thereof. In particular, the present invention relates to user equipment that manages whether an infant attends and leaves or not a kindergarten or children's home and allows an infant to check attending or leaving with an interest, a method of controlling the user equipment, and a recording medium having a computer program.

Further, the preset invention relates to a service providing device that can search an available hospital at a predetermined time and provide a path to the searched hospital, a method of controlling the service providing device, and a recording medium having a computer program.

Further, the present invention relates to user equipment that can allow infants to simply take medical examination and treatment by determining whether it is required to acquire medical data and then acquiring medical data from a service providing device, a service providing device, a method of control them, and a recording medium having a computer program.

2. Description of the Related Art

Infants go around with their curiosity regardless of intention of parents or teachers, so they cause accidents unless parents or teachers take care of them with a concern.

In particular, as dual-carrier couples have increased in recent years, infants spend most time in kindergartens or children's home, but infants are not all completely cared due to lack of childcare teachers and the features of the infants who have little power of concentration and frequently make a sudden action.

For example, kindergartens and children's home generally use vehicles to carry kindergarteners, but sometimes, kindergarteners do not get off due to doze and childcare teachers cannot find them due to complicated situations, so the kindergartners get into danger. Accordingly, parents of the infants who carried by vehicles want to accurately know whether their children have attended/leaved kindergartens.

However, most infants think it trouble to record whether they attend or leave kindergartens or children's home.

Meanwhile, one of the problems in childcare of infants is the matter of health of the infants. Since infants' bodies are not matured at, they are vulnerable to disease and they need to go to a hospital in many cases.

Accordingly, it is required to develop a service providing device that can provide a list of available hospitals and paths to the searched hospitals, when an infant is sick.

Further, user equipment and a service providing device that can allow infants to take medical examination and treatment, when they go to a hospital due to a disease.

### PRIOR ART DOCUMENT

### Patent Document

Korean Patent Publication No. 10-2012-0100350 [Title: Child information delivery system]

Korean Patent Publication No. 10-2007-0059354 [Title: Method for searching a hospital emergency in hospital direction search system]

### SUMMARY OF THE INVENTION

An object of the present invention is to provide user equipment that makes infants actively check their attending and leaving by arousing their interest in order to sense their attending/leaving through NFC tagging and lets their parents know it in real time, in order to minimize inconvenience of a user, a method of controlling the user equipment, and a recording medium having a computer program.

Further, another object of the present invention is to provide user equipment that can output greeting messages set for each infant on the basis of attending/leaving management data for infants and medical data of infants, a method of controlling the user equipment, and a recording medium having a computer program.

Further, another object of the present invention is to provide a service providing device that can provide a user with a list of actually available hospitals in consideration of time to be taken to reach hospitals and to register in the hospitals and that can provide information about the closest hospital in the available hospitals, a method of controlling the service providing device, and a recording medium having a computer program.

Further, another object of the present invention is to provide a service providing device that can provide information about a hospital that a user wants to use and that can provide medical data of a user in a simple way, a method of controlling the service providing device, and a recording medium having a computer program.

Further, another object of the present invention is to provide user equipment that can acquire medical data after determining whether it is required to acquire medical data, a service providing device, a method of controlling them, and a recording medium having a computer program.

Further, another object of the present invention is to provide user equipment that can allow infants to simply take medical examination and treatment, using electronic kindergartener notebooks for infants, a service providing device, a method of controlling them, and a recording medium having a computer program.

User equipment according to an embodiment of the present invention may include: a tag information management unit that acquires infant identification information; a photographing unit that acquires infant photograph information corresponding to the infant identification information; a control unit that acquires attending/leaving management data on the basis of at least one of the infant identification information, the infant photograph information, and time information when the tag information management unit acquires the infant identification information, and that acquires a greeting message on the basis of the infant identification information; and an alarming unit that outputs a greeting message.

As an example of the present invention, the control unit may include an attending/leaving management module that acquires the attending/leaving management data on the basis of at least one of the infant identification information, the infant photograph information, and the time information.

As an example of the present invention, the control unit may include a medical data management module keeping infant medical data including at least one of disease history information, vaccination history information, medication information, food intake information, and sleeping information, according to the infant identification information.

As an example of the present invention, the control unit may acquire a greeting message on the basis of at least one of the infant identification information, the attending/leaving management data, and the infant medical data.

As an example of the present invention, the greeting message may have at least one of a name period based on the infant identification information, a greeting period based on the attending/leaving management data, and an additional period based on the infant medical data.

As an example of the present invention, the name period may include the name of an infant, the greeting period may include an attending greeting or a leaving greeting, and the additional period may include an asking message.

As an example of the present invention, the user equipment may further include a communication unit that receives the infant identification information from an NFC reader in a terminal cradle.

As an example of the present invention, the alarming unit may include at least one of a voice output module and a video output module.

A service providing device according to another embodiment of the present invention may include; a medical request data collecting unit that acquires medical request data from user equipment; a control unit that acquires available hospital information on the basis of the medical request data and hospital data, and necessary time information of the available hospital information and acquires path data of at least one of hospitals included in the available hospital information on the basis of the necessary time information; and a communication unit that transmits the path data to the terminal.

As an example of the present invention, the necessary time information may include movement time information and necessary registration time information of a hospital.

As an example of the present invention, the medical request data may include at least one of date information, time information, requester identification information, terminal location information, and symptom information.

As an example of the present invention, the hospital data may include at least one of working day information, working hour information, medical department information, and present state information of hospitals.

As an example of the present invention, the control unit may include an available hospital collecting module that acquires available hospital information on the basis of symptom information included in the medical request data and medical department information included in the hospital data.

As an example of the present invention, the available hospital collecting module may acquire available hospital information on the basis of date information included in the medical request data and working day information included in the hospital data.

As an example of the present invention, the control unit may include a necessary time calculation module that acquires movement time information of hospitals included in the available hospital information on the basis of traffic information and terminal location information included in the medical request data.

As an example of the present invention, the available hospital collecting module may acquire available hospital information on the basis of the movement time information, necessary registration time information, and working hour information included in the hospital data.

As an example of the present invention, the control unit may acquire path data of a hospital of which the necessary time is the shortest in movement time of hospitals included in the available hospital information.

As an example of the present invention, the service providing device may further include a medical data management unit including medical data that includes at least one of disease history information, vaccination history information, and attending physician information according to requester identification information.

As an example of the present invention, the control unit may acquire path data of a hospital corresponding to attending physician information on the basis of requester identification information included in medical request data and attending physician information included in medical data.

A service providing device according to another embodiment of the present invention may include: a requester identification information management unit that acquires requester identification information from user equipment; a user equipment location information management unit that acquires user equipment location information from the user equipment; a guide page management unit that acquires a protector consent guide page on the basis of the requester identification information, the user equipment location information, and hospital area data and transmits the protector consent guide page to the user equipment; and a medical data management unit that acquires medical data according to requester identification information on the basis of protector consent information based on the protector consent guide page and transmits the medical data to the user equipment.

As an example of the present invention, the service providing system may further include a storage unit that keeps at least one of hospital area data and medical data according to requester identification information, in which the medical data may include at least one of disease history information, vaccination history information, medication information, food intake information, and sleeping information.

As an example of the present invention, the storage unit may keep requester identification information acquired from the user equipment.

As an example of the present invention, the guide page management unit may acquire a protector consent guide page, when the user equipment location information is in the hospital area.

As an example of the present invention, the medical data management unit may compare the protector consent information with predetermined security data, and it may acquire medical data according to the requester identification information, when the protector consent information and the predetermined security data are matched.

The present invention can provide user equipment that makes infants actively check their attending and leaving by arousing their interest in order to sense their attending/leaving through NFC tagging and lets their parents know it in real time, a method of controlling the user equipment, and a recording medium having a computer program.

Further, the present invention can provide user equipment that can output greeting messages set for each infant on the basis of attending/leaving management data for infants and medical data of infants, a method of controlling the user equipment, and a recording medium having a computer program.

Further, the present invention can provide a service providing device that can provide a user with a list of actually available hospitals in consideration of time to be taken to reach hospitals and to register in the hospitals and that can provide information about the closest hospital in the available hospitals, a method of controlling the service providing device, and a recording medium having a computer program.

Further, the present invention can provide a service providing device that can provide information about a hospital that a user wants to use and that can provide medical data of a user in a simple way, a method of controlling the service providing device, and a recording medium having a computer program.

Further, the present invention can provide user equipment that can acquire medical data after determining whether it is required to acquire medical data, a service providing device, a method of controlling them, and a recording medium having a computer program.

Further, the present invention can provide user equipment that can allow infants to simply take medical examination and treatment, using electronic kindergarten notebooks for infants, a service providing device, a method of controlling them, and a recording medium having a computer program.

### BRIEF DESCRIPTION OF THE DRAWINGS

FIG. 1 is a diagram illustrating a network configuration for an infant management system according to an embodiment of the present invention.

FIG. 2 is a diagram illustrating the detailed configuration of a teacher terminal according to an embodiment of the present invention.

FIGS. 3A and 3B are diagrams illustrating an example of a greeting message.

FIG. 4 is a diagram illustrating a terminal cradle according to an embodiment of the present invention.

FIG. 5 is a diagram illustrating the detailed configuration of a service providing device according to an embodiment of the present invention.

FIG. 6 is a flowchart illustrating a method of controlling an infant management system according to an embodiment of the present invention.

FIG. 7 is a diagram illustrating the configuration of a hospital guide system according to an embodiment of the present invention.

FIG. 8 is a block diagram illustrating a terminal according to an embodiment of the present invention.

FIGS. 9A and 9B are diagrams illustrating an example of a way that a terminal acquires symptom information and medical data request information from a user.

FIG. 10 is a block diagram illustrating a service providing device according to an embodiment of the present invention.

FIG. 11 is a diagram illustrating an example of medical request data according to an embodiment of the present invention.

FIG. 12 is a diagram illustrating an example of hospital data according to an embodiment of the present invention.

FIG. 13 is a diagram illustrating an example of holidays of a hospital.

FIG. 14 is a diagram illustrating an example of necessary time acquired by a necessary time calculation module.

FIG. 15 is a diagram illustrating a method of controlling a hospital guide system according to an embodiment of the present invention.

FIG. 16 is a diagram illustrating an example of a way that a terminal displays path data.

FIG. 17 is a diagram illustrating the configuration of medical data providing system according to an embodiment of the present invention.

FIG. 18 is a block diagram illustrating user equipment according to an embodiment of the present invention.

FIG. 19 is a block diagram illustrating a service providing device according to an embodiment of the present invention.

FIG. 20 is a signal flowchart illustrating a process of transmitting/receiving data according to a first embodiment in a medical data providing system of the preset invention.

FIG. 21 is a diagram illustrating an example of a way of acquiring a protector consent guide page on the basis of user equipment location information and hospital area data.

FIG. 22 is a diagram illustrating an example of a protector consent guide page displayed on user equipment.

FIGS. 23A and 233 are diagrams illustrating an example of a way that a user equipment displays medical data of an infant.

FIG. 24 is a signal flowchart illustrating a process of transmitting/receiving data according to a second embodiment in a medical data providing system of the preset invention.

### DETAILED DESCRIPTION OF THE PREFERRED EMBODIMENTS

Terminologies used in the specification are used to explain particular embodiments and are not intended to limit the scope of the invention. In addition unless stated specifically otherwise in the specification, the terminologies used in the specification should be construed to have meanings generally understood by those skilled in the art but should not be construed to have unduly exaggerated or reduced meanings. In addition, even if the terminologies used in the specification are incorrect terminologies in expressing the idea of the present invention, these incorrect terminologies should be replaced with correct terminologies so that those skilled in the art can correctly understand the present invention. Moreover, general terms used in the specification should be construed as defined in the dictionary or according to the context and should not be construed to have unduly reduced meanings.

Hereinafter, preferred embodiments of the present invention will be described in detail with reference to the accompanying drawings so that those skilled in the art can easily practice the preferred embodiments. Throughout the drawings, the same or similar elements are denoted by the same reference numerals and explanation of which will not be repeated for the purpose of brevity of description. In the following detailed description of the present invention, concrete description on related functions or constructions will be omitted if it is deemed that the functions and/or constructions may unnecessarily obscure the gist of the present invention. Accordingly, embodiments described in the specification and elements illustrated in the drawings are illustrative only and do not cover all of the technical ideas of the present invention. It should be, therefore, understood that these embodiments and elements may be replaced with different equivalents and modifications at the point of time of filing the present application.

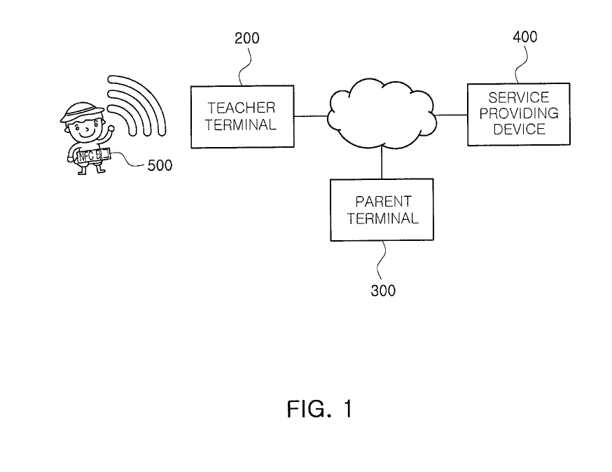

FIG. 1 is a diagram illustrating a network configuration for an infant management system according to an embodiment of the present invention.

An infant management system according to an embodiment of the present invention may include a teacher terminal 200, a parent terminal 300, and service providing device 400.

The teacher terminal 200 and the parent terminal 300 have an application for integrated infant management and they can use a communication interaction service through the application. Herein, the communication interaction service means interaction for communication for transmitting and checking notices in real time through the teacher terminal 200 and the parent terminal 300, when there is a notice about an infant between a teacher and a parent.

To this end, the teacher terminal 200 and the parent terminal 300 may include a smartphone, a notebook, a tablet PC, and a computer, but they are not limited thereto and any devices on which an application can be installed and which can transmit/receive data and perform integrated infant management can be used. The teacher terminal 200 and the parent terminal 300 may be defined as user equipment.

Further, the teacher terminal 200 may be an exclusive terminal equipped with a reader that can acquire identification information of infants through NFC tagging from an NFC tag 500. Further, the teacher terminal 200 can recognize the identification information of infants through the NFC tag 500 tagged through the reader and can receive and provide event information of infants (infant event information) to the service providing device 400 or the parent terminal 300.

Herein, the infant event information means matters, which need to be communicated between teachers and parents, and may include, for example, infant attending/leaving information saying situations of attending/leaving of infants, infant photographing information having images of infants, infant notice information about events happened to infants, and infant medical data exhibiting the health conditions of infants.

Meanwhile, the service providing device 400 stated herein is a general term including all kinds of electronic devices that keep data relevant to services required by terminals and support operation of application in the terminals by transmitting/receiving the data to/from the terminals.

In an embodiment of the present invention, the NFC tag 500 of an infant includes information that allows for recognizing an infant, and for example, includes at least one of identification code information, an infant name, institution information, teacher information, a parent's phone number, and NFC tag classification information. In particular, the NFC tag 500 basically includes an infant name and institution information and the parent's phone number may be separately kept as infant information in the service providing device 400. The teacher information includes personal information of a teacher and terminal information of the teacher terminal 200 and the terminal information of the teacher terminal 200 may be the phone number of a terminal or ID information given to the teacher terminal.

The NFC tag 500 may be classified into an infant's NFC tag and a teacher's NFC tag.

The infant's NFC tag means an NFC tag implemented in the types of a bracelet, a card, and a necklace and possessed by an infant attending to a corresponding institution. The teacher's NFC tag means an NFC tag including NFC tags of a plurality of infants on one board and possessed by a teacher pertaining to a corresponding institution.

The parent terminal 300 is a terminal possessed by a parent of an infant. The parent terminal 300 can receive event information of an infant from the teacher terminal 200 or the service providing device 400 and display and check the received event information. This can be provided through an infant application installed on the parent terminal 300.

Further, the parent terminal 300 can also transmit event information of an infant, using an infant application, through the service providing device 400 or directly to the teacher terminal 200.

The service providing device 400 provides an application for integrated infant management to the teacher terminal 200 or the parent terminal 300 and provides an interaction service between a parent and an institution relating to an infant through the application.

In detail, the service providing device 400 according to an embodiment of the present invention can receive infant event information and infant identification information from the teacher terminal 200. Further, the service providing device 400 can add the received infant event information to an infant management list, finds parent terminal information matched with the received infant identification information, and provide the received infant event information to the parent terminal.

Further, the service providing device 400 can receive the parent terminal information and the infant event information from the parent terminal 300. Further, the service providing device 400 can add the received infant event information to an infant management list, finds teacher terminal information matched with the received parent terminal information, and provide the received infant event information to the teacher terminal.

As described above, the infant management system according to an embodiment of the present invention can provide a communication interaction service allowing the parent terminal 300 and the teacher terminal 200 pertaining to the institution relating to an infant to share infant event information through the service providing device 400.

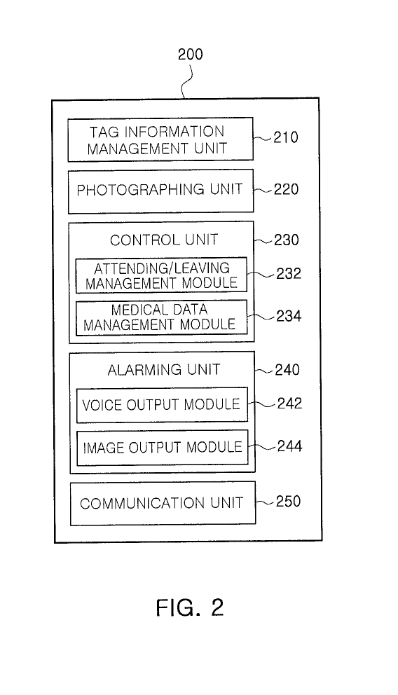

FIG. 2 is a diagram illustrating the detailed configuration of a teacher terminal according to an embodiment of the present invention.

The teacher terminal 200 according to an embodiment of the present invention may include a tag information management unit 210, a photographing unit 220, a control unit 230, an alarming unit 240, and a communication unit 250.

The tag information management unit 210 can acquire infant identification information.

Herein, the infant identification information means information allowing identification of an infant, and for example, may include at least one of identification code information, an infant name, institution information, teacher information, a parent's phone number, and NFC tag classification information.

For example, the tag information management unit 210 may include an NFC reader that can acquire infant identification information from an NFC tag. Further, the communication unit 250 can receive infant identification information from an NFC reader in a terminal cradle and the tag information management unit 210 can acquire the infant identification information from the communication unit 210.

The photographing unit 220 can acquire infant photograph information corresponding to the infant identification information acquired by the tag information management unit 210. Herein, the infant photograph information may be an image of the face of an infant corresponding to the infant identification information.

The control unit 230 can control the entire function of the teacher terminal functionally in combination with the tag information management unit 210, the photographing unit 220, the alarming unit 240, and the communication unit 250. Further, the control unit 240 can acquire time information when the tag information management unit acquires infant identification information.

The communication unit 250 can transmit infant identification information acquired by the tag information management unit 210, infant photograph information acquired by the photographing unit 220, and time information acquired by the control unit 230 to the service providing device 300.

Further, the communication unit 250 can receive infant identification information from the NFC reader in the terminal cradle.

The alarming unit 240 can output a signal for saying an event generated in the teacher terminal 200. Events that are generated in the teacher terminal 200 may be attending of an infant, leaving of an infant, and the like. The alarming unit 240 may output a video signal or an audio signal. To this end, the alarming unit 240 may include a video output module 244 and an audio output module 242. The alarming unit 240 may output a signal for saying generation of an event, for example, through vibration other than the video signal or the audio signal.

The control unit 230 may include an attending/leaving management module 232 and a medical data management module 234.

The attending/leaving management module 232 can acquire attending/leaving management data on the basis of infant identification information, infant photograph information, and time information.

Herein, the attending/leaving management data is data including whether infants attend/leave or not and information of the time of attending/leaving. For example, the attending/leaving management data may include attending and leaving time of infants and images at attending or leaving.

The attending/leaving management module 232 can check time information of the infant identification information acquired by the tag information management unit, match the checked time information to attending/leaving time, and keep it in the attending/leaving management data.

The medical data management module 234 can keep infant medical data. Herein, the infant medical data may include information saying the health conditions of infants. For example, the infant medical data may include medical history information, vaccination history information, medication information, food intake information, and sleeping information according to infant identification information.

Meanwhile, the attending/leaving management module 232 may be provided in the service providing device 400. In this process, the service providing device 400 can acquire infant identification information, infant photograph information, and time information from the teacher terminal 200, acquire attending/leaving management data on the basis of the acquired infant identification information, infant photograph information, and time information, and transmit the data to the teacher terminal 200.

Further, the medical data management module 234 may be provided in the service providing device 400. In this configuration, the teacher terminal 200 can receive infant medical data from the service providing device 400.

The control unit 230 can acquire a greeting message on the basis of the infant identification information. Further, the control unit 230 can acquire a greeting message on the basis of the infant identification information, the attending/leaving management data, and the infant medical data.

Herein, the greeting message may be information outputted when an NFC tag of an infant is tagged to the teacher terminal 200 while the infant attends or leaves a kindergarten.

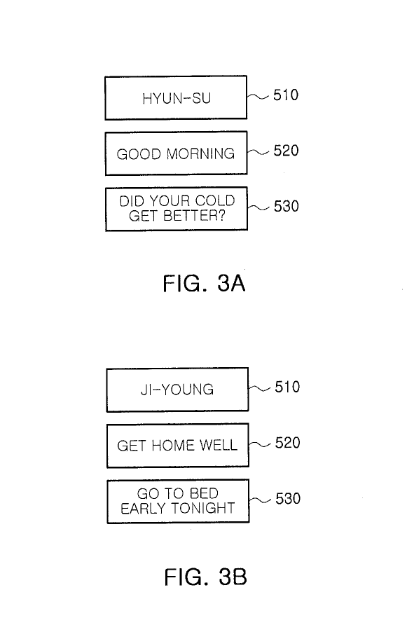

FIGS. 3A and 3B are diagrams illustrating an example of a greeting message.

Referring to FIGS. 3A and 3B, a greeting message may include at least one of a name period 510 based on infant identification information, a greeting period 520 based on attending/leaving management data, and an additional period 530 based on infant medical data.

For example, the name period may be a message 510 that calls an infant attending or leaving a kindergarten. To this end, the name period may be created on the basis of the name of an infant included in infant identification information (See FIGS. 3A and 3B).

Further, the greeting period may include greetings to an infant attending or leaving a kindergarten. To this end, the greeting period may be created on the basis of the attending/leaving management data. This is because the attending/leaving management data can say whether an infant is attending or leaving.

In this process, the greeting period may include an attending greeting or a leaving greeting to an infant. For example, when the control unit 230 finds an infant who is attending a kindergarten, it may create a greeting period 520 having an attending greeting (see FIG. 3A). Further, when the control unit 230 find an infant who is leaving a kindergarten, it may create a greeting period 520 having a leaving greeting (see FIG. 3B).

Further, the additional period 530 may include an asking message for an infant attending or leaving. To this end, the additional period 530 may be created on the basis of infant medical data. For example, when the control unit 230 finds a disease of an infant from infant medical data, it may create an additional period 530 having the disease condition of the infant (see FIGS. 3A and 3B).

Meanwhile, the alarming unit 240 can output the greeting message acquired by the control unit 230. For example, the alarming unit 240 may output a greeting message through a voice or an image.

As described above, it is possible to output suitable greeting messages for infants on the basis of attending/leaving management data of infants and infant medical data. In this process, the teacher terminal according to an embodiment of the present invention can arouse infants' interest through greeting messages so that they actively check their attending and leaving.

Meanwhile, the alarming unit 240 can output attending/leaving states on the basis of attending/leaving management data. For example, when the control unit 230 finds an infant who is attending, the alarming unit 240 can output a message saying the attendance of the infant. Further, when the control unit 230 finds an infant who is leaving, the alarming unit 240 can output a message saying the leaving of the infant.

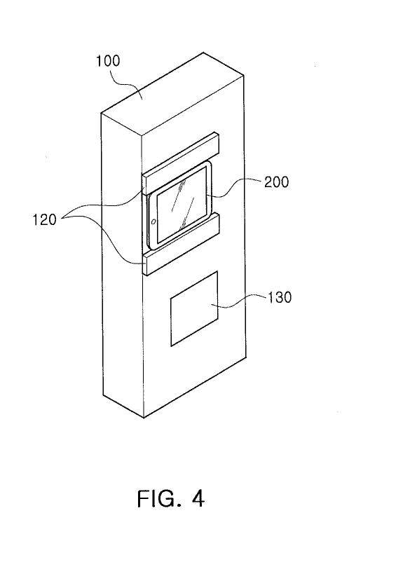

FIG. 4 is a diagram illustrating a terminal cradle according to an embodiment of the present invention.

The terminal cradle according to an embodiment of the present invention may include a cradle body 100, a terminal retainer 120, and an NFC reader 130.

The cradle body 100 may provide an area for mounting a teacher terminal.

The terminal retainer 120 can hold and release a teacher terminal. That is, the teacher terminal 200 can be mounted on the terminal cradle by the terminal retainer 120. Further, the teacher terminal 200 can be separated from the terminal retainer 120.

The NFC reader 130 can recognize infant identification information included in an NFC tag through NFC tagging. In this process, the NFC reader 130 can provide the recognized infant identification information to the teacher terminal 200.

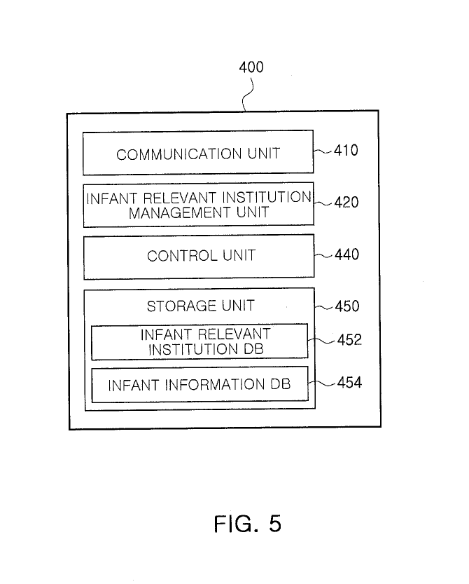

FIG. 5 is a diagram illustrating the detailed configuration of a service providing device according to an embodiment of the present invention.

The service providing device 400 according to an embodiment of the present invention may include a communication unit 410, an infant relevant institution management unit 420, a control unit 440, and a storage unit 450.

The communication unit 410 may include one or more modules allowing for wireless communication with a network including the service providing device 400 and the teacher terminal 200 or a network including the service providing device 400 and the parent terminal 300.

In particular, the communication unit 400 can receive infant identification information, infant photograph information, and time information from the teacher terminal 200.

The infant relevant institution management unit 420 can keep and manage information about infant relevant institutions (including an educational institution and a childcare institution) subscribing an infant management service.

Further, the infant relevant institution management unit 420 can assign IDs to teacher terminals distributed from infant relevant institutions and manage the teacher terminal on the basis of the assigned ID information.

The control unit 440 can control entire operation of the service providing device functionally in combination with the communication unit 410, the infant relevant institution management unit 420, and the storage unit 450.

The control unit 440 can check reception time information on the basis of infant identification information received from the communication unit 410, match the check reception time information to attending/leaving time, and keep it on an attending/leaving management list.

And, the control unit 440 can find parent information matched with infant identification information on the basis of infant data kept in the attending/leaving management list and transmit attending/leaving information to the found parent terminal.

In this process, the control unit 440 can primarily transmit a notice message saying there is attending/leaving information to a parent terminal. When the control unit 440 receives a request to check in detail a notice message transmitted from a parent terminal, it can transmit attending/leaving information of a corresponding infant to the parent terminal.

Herein, the attending/leaving information of an infant may include infant identification information, infant photograph information, and attending/leaving time information.

Further, parent information may be the phone number of a parent terminal or an ID number given to a parent terminal. For example, when the control unit 440 transmits data, it can prevent exposition of the individual phone number of a parent terminal by transmitting the data on the basis of an ID.

The storage unit 450 may include an infant relevant institution DB 452 keeping information about infant relevant institutions and an infant information DB 454 including infant identification information.

Further, the storage unit 450 can keep a history of transmitting attending/leaving information to a parent terminal and a history of transmitting attending/leaving information directly to a parent terminal from a teacher terminal.

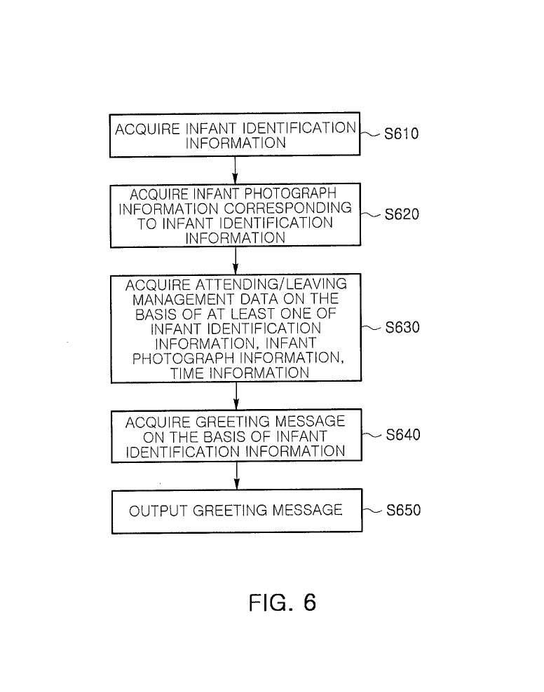

FIG. 6 is a flowchart illustrating a method of controlling an infant management system according to an embodiment of the present invention.

According to an embodiment of the present invention, the teacher terminal 200 can acquire infant identification information through tagging (S610) with an infant NFC tag.

In this process, the teacher terminal 200 can acquire infant photograph information corresponding to the acquired infant identification information (S620).

Further, the teacher terminal 200 can acquire attending/leaving management data on the basis of at least one of infant identification information, infant photograph information, and time information (S630).

According to an embodiment of the present invention, the teacher terminal 200 can acquire a greeting message on the basis of infant identification information, attending/leaving management data, and infant medical data (S640).

Further, the teacher terminal 200 can output the acquired greeting message (S650).

As described above, it is possible to output suitable greeting messages for infants on the basis of attending/leaving management data of infants and infant medical data. In this process, the teacher terminal according to an embodiment of the present invention can arouse infants' interest through greeting messages so that they actively check their attending and leaving.

A method of controlling user equipment according to an embodiment of the present invention can be recorded in a computer program, and codes and code segments of the computer program can be easily inferred by computer programmers in the field. Further, the computer program is stored in computer readable media, and read and executed by a computer or user equipment according to an embodiment of the present invention, so the method of controlling the user equipment can be implemented.

The computer readable media include a magnetic recording medium, an optical recording medium, and a carrier wave medium. A computer program for achieving the method of controlling user equipment according to an embodiment of the present invention may be stored and installed in a built-in memory in the user equipment. Alternatively, an external memory such as a smart card in which a computer program for achieving the method of controlling user equipment according to an embodiment of the present invention is stored and installed may be mounted on the user equipment through an interface.

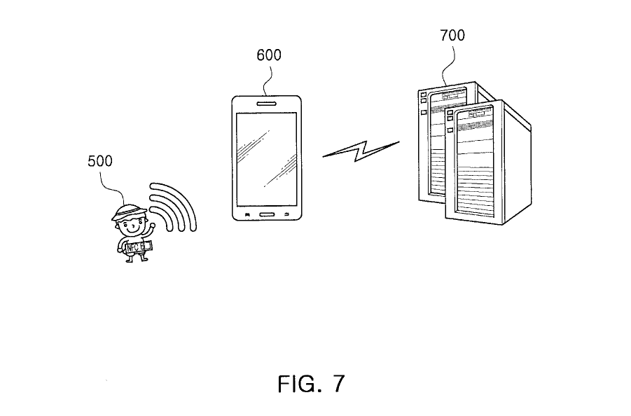

FIG. 7 is a diagram illustrating the configuration of a hospital guide system according to an embodiment of the present invention.

The user equipment described herein is a general term including all kinds of user equipment receiving orders from a user and performing selected work, such as a tablet PC, a notebook, and a desktop, including hand-held type terminals such as a mobile communication terminal.

The service providing device described herein is a general term including all kinds of electronic devices keeping data relating to services required by user equipment, and supporting operation of applications in the user equipment by transmitting/receiving data to/from the user equipment.

As illustrated in FIG. 7, a hospital guide system 600 may include user equipment 600 and a service providing device 700. The components of the hospital guide system illustrated in FIG. 7 are not all necessary components, and the hospital guide system may be composed of components much or less than the components illustrated in FIG. 7.

According to an embodiment of the present invention, the user equipment 600 can acquire requester identification information from an NFC tag 1000 and transmit medical request data including the acquired requester identification information to the service providing device. The service providing device 700 can acquire available hospital information and information about time to be taken to go to hospitals included in the available hospital information on the basis of the received medical request data and hospital data and acquire path data of an optimal hospital in the hospitals included in the available hospital information on the basis of the acquired necessary time information. Further, the service providing device 700 can transmit the acquired path data to the user equipment 600.

Accordingly, the present invention can provide a list of actually available hospitals for a user in consideration of time to be taken to reach hospitals and to register in hospitals and provide a path to an optimal hospital in the available hospitals, so it is possible to improve convenience for users.

Meanwhile, the requester identification information may include data allowing for identifying an infant having the NFC tag 1000, for example, it may include an infant name, protective institution information, teacher information, and a parent's phone number.

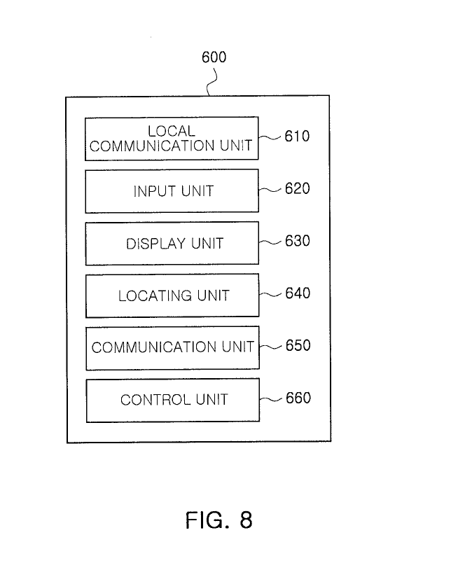

FIG. 8 is a block diagram illustrating user equipment according to an embodiment of the present invention.

Referring to FIG. 8, the user equipment 600 may include a local communication unit 610, an input unit 620, a display unit 630, a locating unit 640, a communication unit 650, and a control unit 660.

The local communication unit 610 means a module for local communication, and for example, it may include an NFC tag recognition module.

The local communication unit 610 can acquire requester identification information from the NFC tag 1000.

The input unit 620 can acquire input data for controlling operation of the user equipment from a user. For example, the input unit 620 can acquire symptom information.

Herein, the symptom information may mean a bodily appearance of a person who needs to go to a hospital. Further, the symptom information may mean medical department that a person needs.

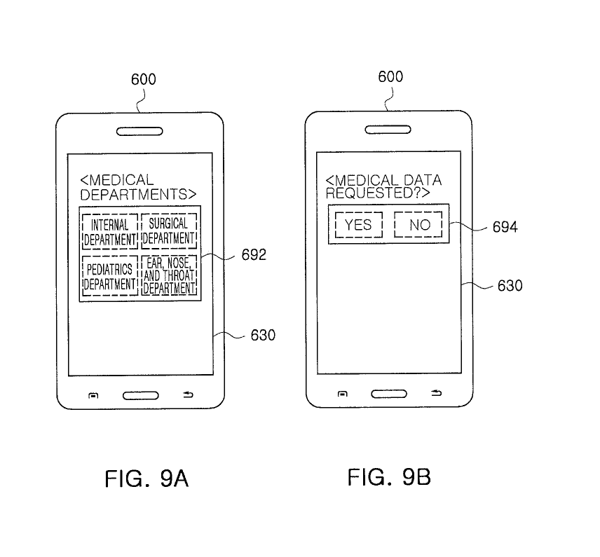

FIGS. 9A and 9B are diagrams illustrating an example of a way that user equipment acquires symptom information and medical data request information from a user.

FIG. 9A is a diagram illustrating an example of a way that user equipment acquires symptom information from a user.

As illustrated in FIG. 9A, the display unit 630 of the user equipment can display a plurality of objects 692 relating to symptom information.

An object described herein is an object to which user's intention or action is applied, and for example, may be an image, a moving image, an icon, sound, e-mail, and SNS post. Further, other various types of objects may be considered.

When any one of a plurality of objects 692 displayed on the display unit 630 is selected, the input unit 620 can acquire symptom information.

Meanwhile, a user can input detailed symptom through the input unit 620.

FIG. 9B is a diagram illustrating an example of a way that user equipment acquires medical data request information from a user.

Herein, the medial data request information may be a request that the user equipment sends to the service providing device to transmit medical data corresponding to requester identification information.

As illustrated in FIG. 9B, the display unit 630 of the user equipment can display a guide window 694 for acquiring medical data request information.

When the guide window 694 displayed on the display unit 630 is selected, the input unit 620 can acquire medical data request information.

Meanwhile, the display unit 630 can display information processed in the user equipment.

The locating unit 640 is provided for locating the user equipment and a GPS (Global Position System) is a typical example.

The control unit 660 can control entire operation of the user equipment 600 functionally in combination with the local communication unit 610, the input unit 620, the display unit 630, the communication unit 650, and the locating unit 640.

Meanwhile, the control unit 660 can acquire date information and time information, when the user equipment 600 acquires requester identification information. Further, the control unit 660 can control the locating unit 640 to acquire user equipment location information.

Meanwhile, the user equipment 600 can acquire medical request data. The medical request data may be a request for the information about hospitals, wherein the infant identified by the requester identification information can take medical examination and treatment, and paths to the hospitals.

The medical request data may include requester identification information, date information, time information, user equipment location information, and symptom information.

The communication unit 650 can transmit or receive data to or from the service providing device 700. For example, the communication unit 650 can transmit medical request data to the service providing device 700.

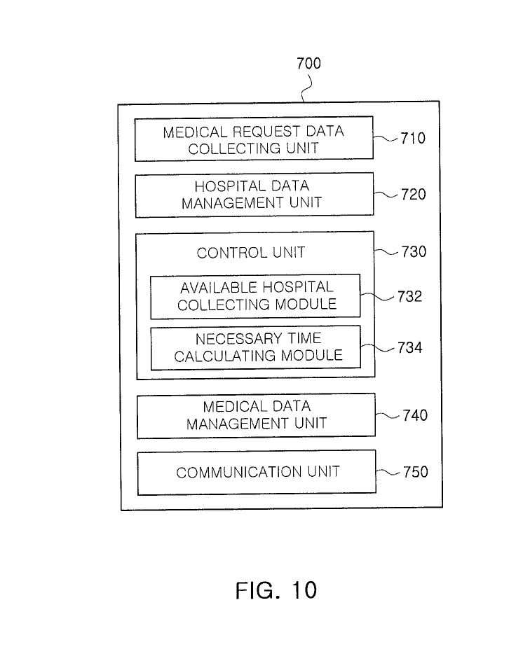

FIG. 10 is a block diagram illustrating a service providing device according to an embodiment of the present invention.

Referring to FIG. 10, the service providing device 700 may include a medical request data collecting unit 710, a hospital data management unit 720, a control unit 730, a medical data management unit 740, and a communication unit 750.

The communication unit 750 can transmit or receive data to or from the user equipment 600.

The medical request data collecting unit 710 can acquire medical request data from the user equipment.

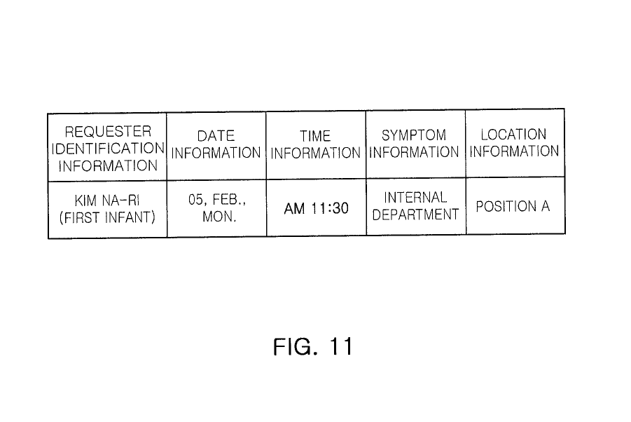

FIG. 11 is a diagram illustrating an example of medical request data according to an embodiment of the present invention.

Referring to FIG. 11, medical request data may include requester identification information (for example, KIM Na-Ri (first infant)), date information when the medical request data was created (for example, Monday, 5 February), time information when the medical request data was created (for example, AM 11:30), symptom information (for example, internal department), and location information (for example, the point where user equipment is positioned).

The hospital data management unit 720 can include data about a plurality of hospitals. For example, the hospital data management unit 720 may include working day information, working hour information, medical department information, and present hospital state information.

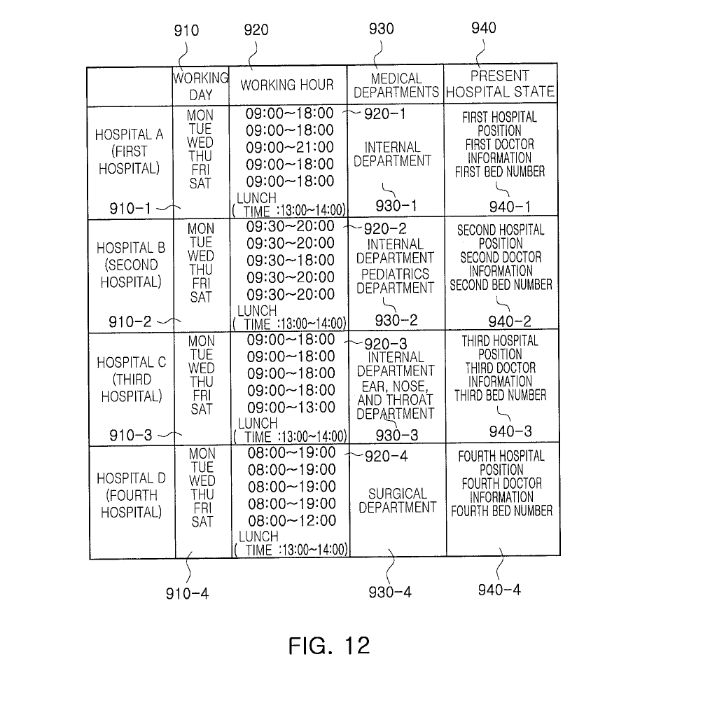

FIG. 12 is a diagram illustrating an example of hospital data according to an embodiment of the present invention.

Referring to FIG. 12, hospital data may include working day information of predetermined hospitals 910, working time information 920, medical department information 930, and present hospital state information 940.

Herein, the working day information 910 may include periodic working days of hospitals and holidays.

The working day information 910-1 of a first hospital exhibits periodic working days of the first hospital.

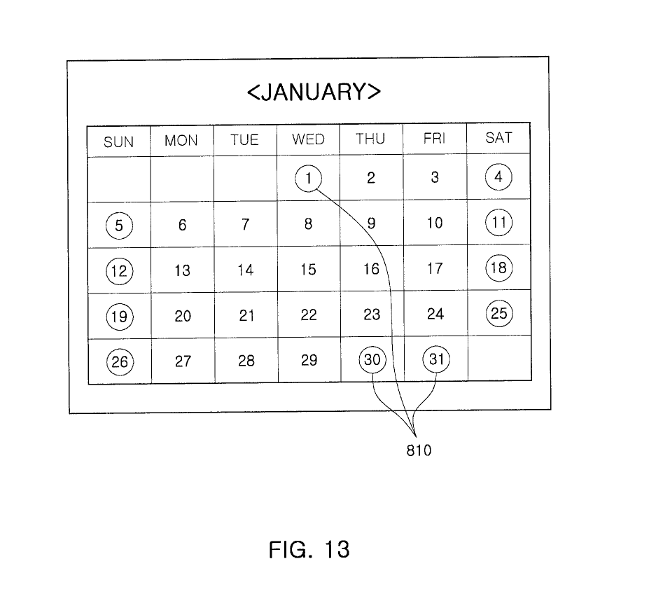

FIG. 13 is a diagram illustrating an example of holidays of a hospital.

Referring to FIG. 13, the working day information 910 may include the dates of non-periodic holidays 810 of a predetermined hospital.

Further, the working hour information 920 may include working hours of working days of hospitals 920.

When the working days of the first hospital are Monday, Tuesday, Wednesday, Thursday, and Friday, the working hour information 920-1 of the first hospital may include the working hours of the days.

Further, the working hour information 920 may include the lunch time of hospitals.

For example, the working hour information 920-1 of the first hospital may include the lunch time (for example, 13:00 to 14:00).

Further, the medical department information 930 may include main medical departments of hospitals.

Further, the present hospital state information 940 may include the location of hospitals, doctor information, and the number of beds.

In this way, the hospital data may include working day information (for example, 910-1, 910-2, 910-3, and 910-4) of hospitals (for example, first hospital, second hospital, third hospital, and fourth hospital), working hour information (for example, 920-1, 920-2, 920-3, and 920-4), medical department information (for example, 930-1, 930-2, 930-3, and 930-4), and the present hospital state information (for example, 940-1, 940-2, 940-3, and 940-4).

The control unit 730 can acquire available hospital information on the basis of medical request data and hospital data.

In detail, the control unit 730 can include an available hospital collecting module 732 that acquires available hospital information on the basis of symptom information included in the medical request data and medical department information included in the hospital data.

For example, referring to FIGS. 11 and 12, since the hospitals corresponding to symptom information (for example, internal department) included in the medical request data in the hospital data are the first hospital, the second hospital, and the third hospital, the available hospital collecting module 732 can set the first hospital, the second hospital, and the third hospital as available hospitals.

Further, the available hospital collecting module 732 can acquire available hospital information on the basis of date information included in the medical request data and working day information included in the hospital data.

For example, referring to FIGS. 11 and 6, since the hospitals that are available at the date (for example, Monday) included in the medical request data in the hospital data are the first hospital and the second hospital, the available hospital collecting module 732 can set the first hospital and the second hospital as available hospitals.

Further, the control unit 730 can acquire necessary time information of the hospitals included in the available hospital information.

In detail, the control unit 730 may include a necessary time calculation module 734 that calculate necessary time information of hospitals included in the available hospital information on the basis of traffic information and user equipment location information included in the medical request data.

Herein, the necessary time information may include movement time information and necessary registration time information of a hospital. Meanwhile, the movement time information means time to be taken to reach to a hospital from the point where the user equipment is positioned.

Further, the necessary registration time information means time to be taken to register or take medical examination in a hospital. For example, since registration is closed at predetermined time before lunch time and at predetermined time before the closing hour in most hospitals, the necessary registration time information is determined in consideration of the time when registration is actually closed in hospitals.

Accordingly, the present invention can provide a list of hospitals where a user can actually take medical examination and treatment quickly.

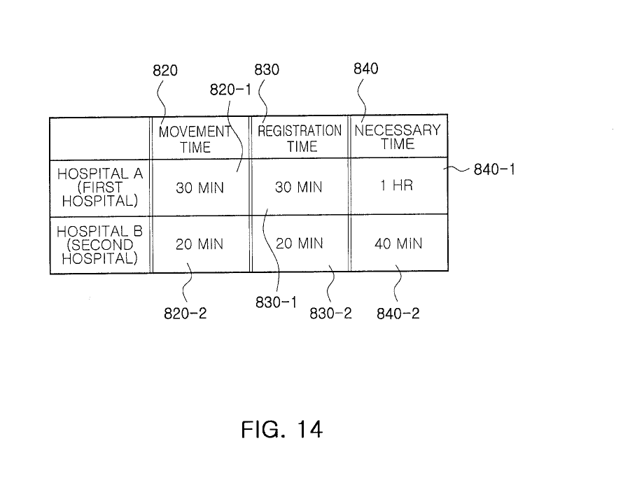

FIG. 14 is a diagram illustrating an example of necessary time acquired by a necessary time calculation module.

In this embodiment, it is assumed that the available hospital collecting module 732 sets the first hospital and the second hospital as available hospitals.

The necessary time calculation module 734 can acquire necessary time information 840-1 and 840-2 on the basis of movement time 820-1 and 820-2 and necessary registration time 830-1 and 830-2 of the hospitals (for example, the first hospital and the second hospital) included in an available hospital list.

Further, the available hospital collecting module 732 can acquire available hospital information on the basis of time information included in the medical request data and necessary time information.

For example, referring to FIGS. 11, 12, and 14, as for the first hospital, a user can reach the first hospital by twelve thirty obtained by subtracting necessary registration time from the start time of lunch time, so the available hospital collecting module 732 can set the first hospital as an available hospital. Further, as for the second hospital, a user can reach the second hospital by twelve forty obtained by subtracting necessary registration time from the start time of lunch time, so the available hospital collecting module 732 can set the second hospital as an available hospital.

Meanwhile, as illustrated in FIG. 14, the necessary registration time information 830 of hospitals may be depend on the hospitals.

Meanwhile, the control unit 730 can acquire path data of at least one of hospitals included in available hospital information on the basis of acquired necessary time information. For example, the control unit 730 can acquire path data of the hospital of which the movement time is the shortest in the movement time to the hospitals included in available hospital information. Further, the control unit 730 can acquire path data of the hospital of which the necessary time is the shortest in the necessary time to the hospitals included in available hospital information.

Referring to FIG. 14, the necessary time of the first hospital is one hour and the necessary time of the second hospital is forty minutes, so the control unit 730 can acquire the path data of the second hospital.

The communication unit 750 can transmit the path data acquired by the control unit 730 to the user equipment 600. In this process, the communication unit 750 can transmit the present hospital state information (for example, doctor information, the number of beds, and the like.) of the hospital selected by the control unit 730 to the user equipment 600.

The medical data management unit 740 may further include medical data including disease history information, vaccination history information, and attending physician information according to the requester identification information.

Meanwhile, the control unit 730 can acquire path data of a hospital corresponding to the attending physician information on the basis of requester identification information and the attending physician information included in medical data.

According to this embodiment, when attending physician information is included in requester identification information, the service providing device 700 can improve convenience for a user by quickly providing information about a hospital that the attending physician works for and the path to the hospital.

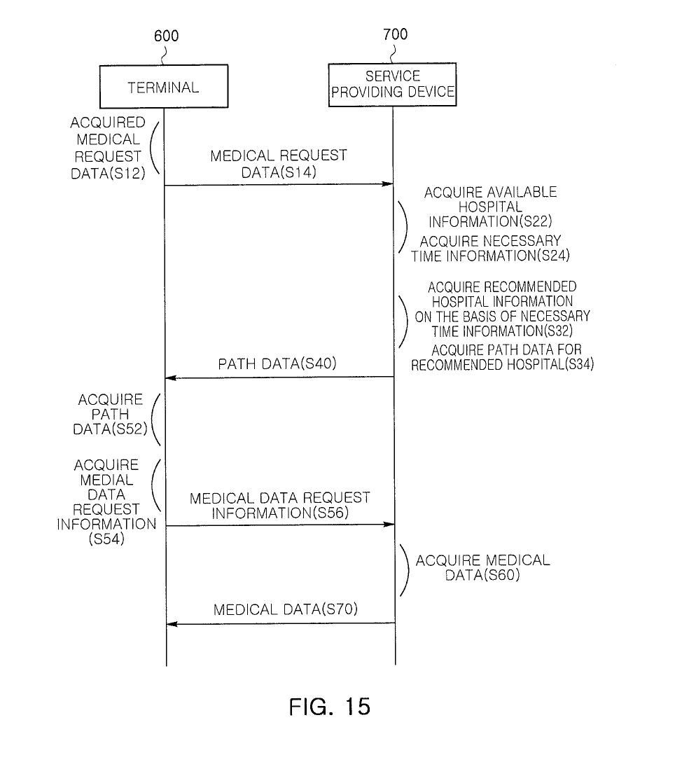

FIG. 15 is a diagram illustrating a method of controlling a hospital guide system according to an embodiment of the present invention.

Referring to FIG. 15, the user equipment 600 can acquire medical request data (S12) and transmit the acquired medical request data to the service providing device 700 (S14).

The service providing device 700 receiving the medical request data can acquire available hospital information on the basis of the acquired medical request data and the hospital data (S22).

Further, the service providing device 700 acquiring the available hospital information can acquire necessary time information of the hospital included in the available hospital information on the basis of traffic information and user equipment location information included in the medical request data (S24).

Further, the service providing device 700 can acquire recommended hospital information on the basis of the acquired necessary time information (S32). Herein, the recommended hospital information may mean a hospital of which the necessary time is the shortest in the necessary time of hospitals included in the available hospital information.

Further, the service providing device 700 can acquire path data of the recommended hospital (S34) and transmit the acquired path data to the user equipment 600 (S40).

The user equipment 600 receiving the path data can display path data (S52).

As described above, the service providing device according to an embodiment of the present invention can provide a list of hospitals where a user can take medical examination and treatment and the information about the closest hospital in the available hospitals in consideration of necessary time and necessary registration time of hospitals.

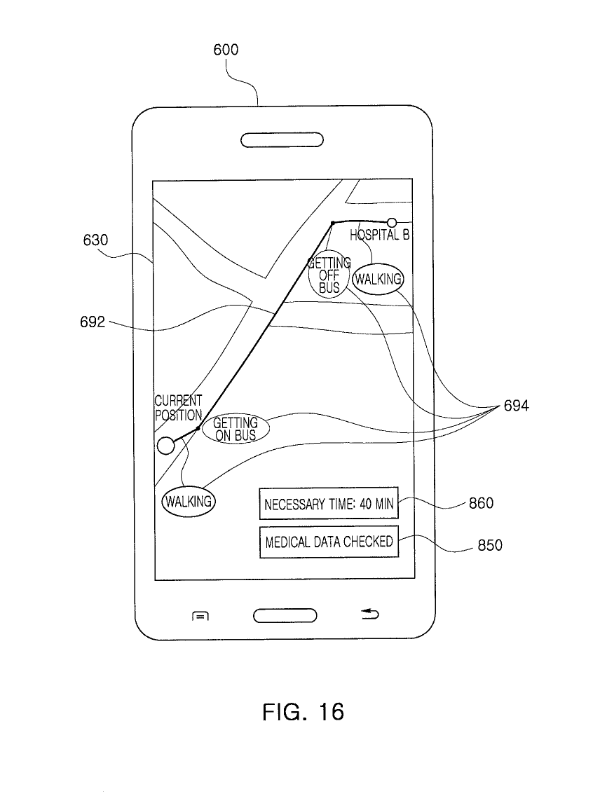

FIG. 16 is a diagram illustrating an example of a way that user equipment displays path data.

Referring to FIG. 16, the path data may include a path 692 from the current location to a recommended hospital and a moving means 694. In this process, the display unit 630 of the user equipment 600 can display the necessary time information 860 of the recommended hospital and an object 850 for acquiring medical data request information.

Referring to FIGS. 15 and 16, the user equipment 600 can acquire medical data request information on the basis of user's input for the object 850 (S54). In this process, the user equipment 600 can transmit the medical data request information to the service providing device 700 (S56).

The control unit of the service providing device 700 receiving the medical data request information can acquire medical data according to requester identification information on the basis of the medical data request information and the medical data (S60).

And, the service providing device 700 can transmit the acquired medical data to the user equipment 600 (S70).

As described above, the service providing device according to an embodiment of the present invention can provide information about a hospital that a user wants to use and provide medical data of a user in a simple way.

A method of controlling a service providing device according to an embodiment of the present invention can be recorded in a computer program, and codes and code segments of the computer program can be easily inferred by computer programmers in the field. The computer program is stored in computer readable media, and read and executed by a computer or a service providing device according to an embodiment of the present invention, so a method of controlling the service providing device can be implemented.

The computer readable media include a magnetic recording medium, an optical recording medium, and a carrier wave medium. A computer program for achieving the method of controlling a service providing device according to an embodiment of the present invention may be stored and installed in a built-in memory in the service providing device. Alternatively, an external memory such as a smart card in which a computer program for achieving the method of controlling a service providing device according to an embodiment of the present invention is stored and installed may be mounted on the service providing device through an interface.

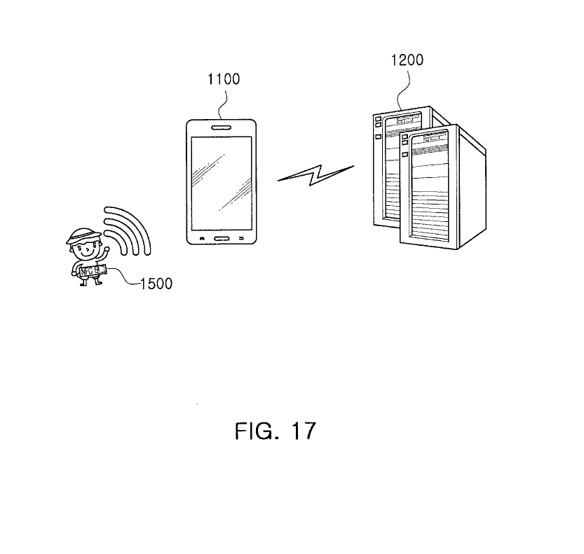

FIG. 17 is a diagram illustrating the configuration of medical data providing system according to another embodiment of the present invention.

As illustrated in FIG. 17, a medical data providing system may include user equipment 1100 and a service providing device 1200. The components of the medical data providing system illustrated in FIG. 17 are not all necessary components, and the medical data providing system may be composed of components much or less than the components illustrated in FIG. 17.

According to an embodiment of the present invention, the user equipment 1100 can acquire requester identification information and user equipment location information from an NFC tag 1500 and can transmit the acquired requester identification information and user equipment location information to the service providing device 1200. The service providing device 1200 can provide medical data to the user equipment 1100, when it determines that the user equipment 1100 is in a hospital on the basis of the received requester identification information, the received user equipment location information, and hospital area data.

Herein, the requester identification information may include data allowing for identifying an infant having the NFC tag 1500, for example, it may include an infant name, protective institution information, teacher information, and a parent's phone number.

Further, the medical data means various items of information used for diagnosing a patient in a hospital, and for example, it may include disease history information of a user, vaccination history information, medication information, food intake information, and sleeping information.

Therefore, according to the present invention, the service providing device 1200 determines whether it is required to acquire medical data of the user equipment and provides medical data to the user equipment 1100, so it can improve convenience for a user.

Further, the present invention can allow infants to easily take medical examination and treatment by providing detailed medical data by interview, using electronic kindergartener notebook data of infants.

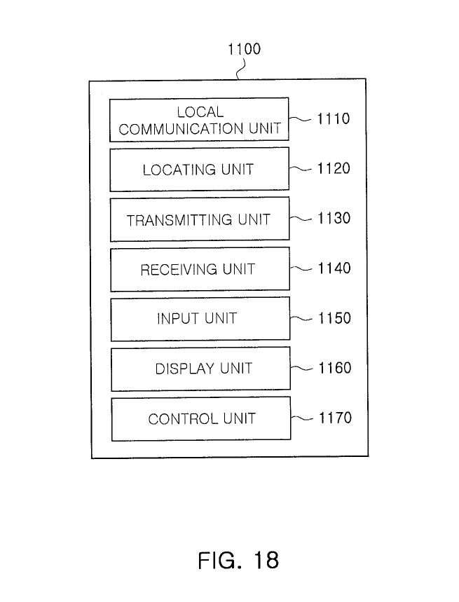

FIG. 18 is a block diagram illustrating user equipment according to an embodiment of the present invention.

Referring to FIG. 18, the user equipment 1100 may include a local communication unit 1110, a locating unit 1120, a transmitting unit 1130, a receiving unit 1140, an input unit 1150, a display unit 1160, and a control unit 1170.

The local communication unit 1110 means a module for local communication, and for example, it may include an NFC tag recognition module.

The local communication unit 1110 can acquire requester identification information from the NFC tag 1500.

The locating unit 1120 is provided for locating the user equipment (acquiring user equipment location information) and a GPS (Global Position System) is a typical example.

The transmitting unit 1130 can transmit data to the service providing device 1200. For example, the transmitting unit 1130 can transmit requester identification information acquired by the local communication unit 1110 and user equipment location information acquired by the locating unit 1120 to the service providing device 1200.

The receiving unit 1140 can receive data from the service providing device 1200. For example, the receiving unit 1140 can receive a protector consent guide page and medical data acquired by the service providing device 1200.

The input unit 1150 can acquire input data for controlling operation of the user equipment from a user. For example, the input unit 1150 can acquire protector consent information.

Herein, the protector consent information exhibits whether a protector consents or not that user equipment receives or displays medical data of infants. The protector consent information may mean not only whether a protector consent, but a password for user equipment to receive or display medical data of infants.

The display unit 1160 can display data to be processed in the user equipment 1100. For example, the display unit 1160 can display a protector consent guide page and medical data received from the service providing device 1200.

Further, the display unit 1160 can display an object for acquiring user input. An object described herein is an object to which user's intention or action is applied, and for example, may be an image, a moving image, an icon, sound, e-mail, and SNS post. Further, other various types of objects may be considered.

The control unit 1170 can control entire operation of the user equipment 1100 functionally in combination with the local communication unit 1110, the locating unit 1120, the transmitting unit 1130, the receiving unit 1140, the input unit 1150, and the display unit 1160.

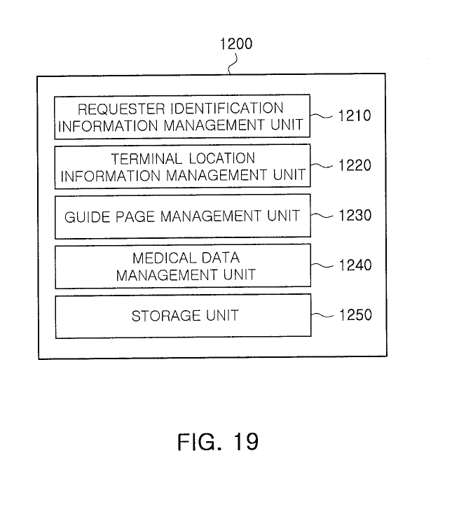

FIG. 19 is a block diagram illustrating a service providing device according to an embodiment of the present invention.

Referring to FIG. 19, the service providing device 1200 may include a requester identification information management unit 1210, a user equipment location information management unit 1220, a guide page management unit 1230, a medical data management unit 1240, and a storage unit 1250.

The requester identification information management unit 1210 can acquire requester identification information from the user equipment 1100.

The user equipment location information management unit 1220 can acquire user equipment location information from the user equipment 1100.

The guide page management unit 1230 can acquire a protector consent guide page on the basis of the requester identification information acquired from the user equipment 1100, the user equipment location information acquired from the user equipment 1100, and hospital area data.

Herein, the hospital area data may be data of the location of hospitals. The storage unit 1250 can keep the hospital area data. Further, the service providing device 1200 can receive the hospital area data from an external server.

The protector consent guide page may include information that requests protectors of infants to consent that user equipment receives or displays medical data of the infants.

In detail, when it is determined that user equipment location information is in a hospital area in the hospital area data, the guide page management unit 1230 can acquire a protector consent guide page corresponding to requester identification information.

Further, the guide page management unit 1230 can transmit the acquired guide page to the user equipment 1100.

The medical data management unit 1240 can acquire medical data according to the requester identification information on the basis of the protector consent information.

For example, the medical data management unit 1240 can compare the protector consent information with predetermined security data, and it acquires medical data according to the requester identification information, when the protector consent information and the predetermined security data are matched.

Further, the medical data management unit 1240 can transmit the acquired medical data to the user equipment 1100.

The storage unit 1250 can keep the hospital area data and medical data according to requester identification information.

Herein, the medical data according to the requester identification information may include medical history information, vaccination history information, medication information, food intake information, and sleeping information according to requester identification information.

Meanwhile, the service providing device 1200 can acquire medical history information, vaccination history information, medication information, food intake information, and sleeping information from an external server (for example, an infant electronic notebook service providing device).

Further, the storage unit 1250 can keep the requester identification information received from the user equipment 1100.

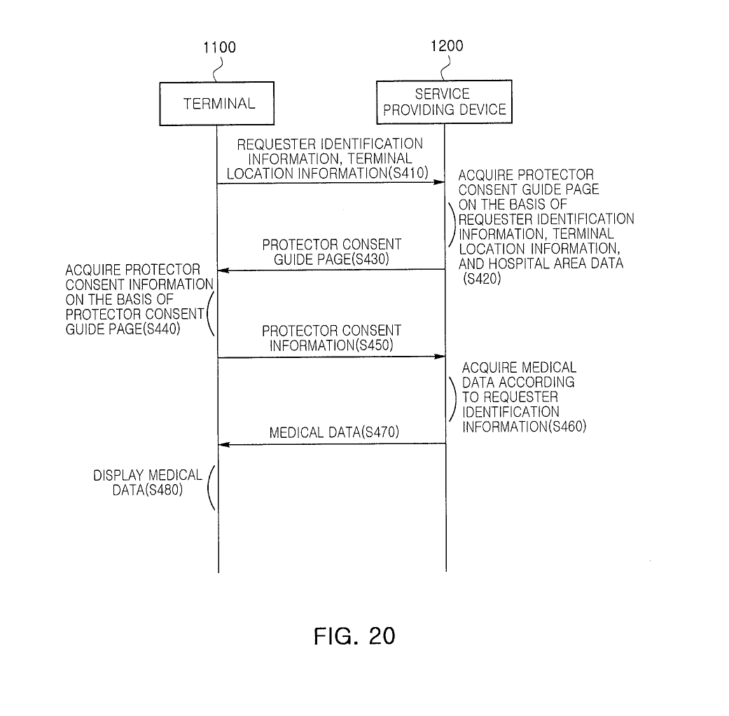

FIG. 20 is a signal flowchart illustrating a process of transmitting/receiving data according to a first embodiment in a medical data providing system of the preset invention.

The user equipment 1100 can acquire requester identification information. For example, the user equipment 1100 can acquire requester identification information through tagging with an infant NFC tag. Herein, the infant NFC tag may mean an NFC tag that an infant has. In this process, the user equipment 1100 can acquire user equipment location information.

Referring to FIG. 20, the user equipment 1100 can transmit the acquired requester identification information and user equipment location information to the service providing device 1200 (S410).

The service providing device 1200 can acquire a protector consent guide page corresponding to requester identification information on the basis of the received user equipment location information and the hospital area data (S420).

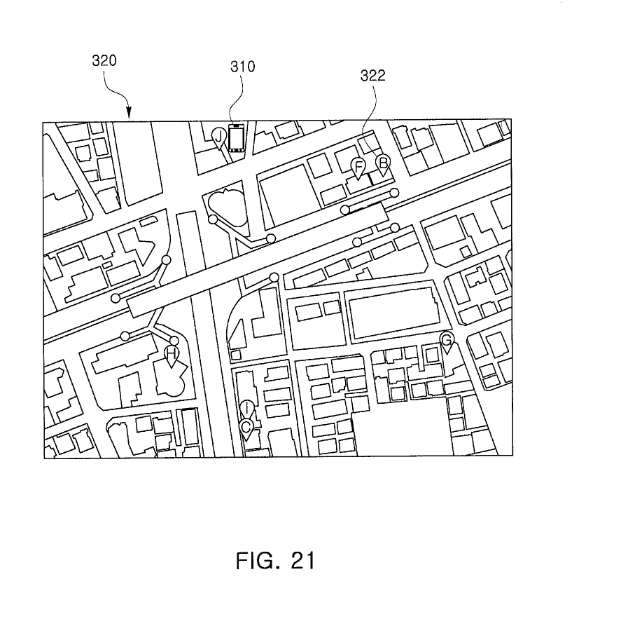

FIG. 21 is a diagram illustrating an example of a way of acquiring a protector consent guide page on the basis of user equipment location information and hospital area data.

As illustrated in FIG. 21, the hospital area data 1320 may include hospital location information (1322) in a map data.

Accordingly, the service providing device 1200 can acquire a protector consent guide page, when the received user equipment location information 1310 corresponds to the hospital location information 1322 (when the user equipment location information is in the hospital area 1322).

The service providing device 1200 can transmit the acquired protector consent guide page to the user equipment 1100 (S430).

The user equipment 1100 can display the received protector consent guide page.

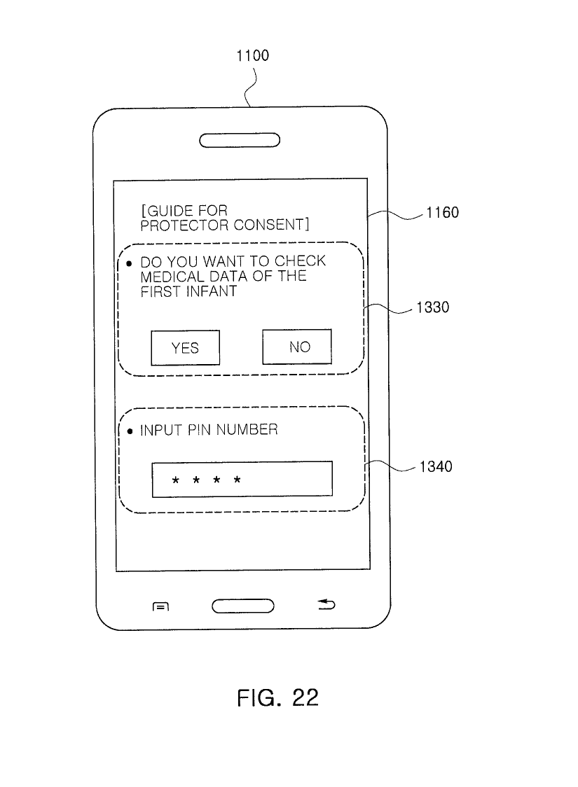

FIG. 22 is a diagram illustrating an example of a protector consent guide page displayed on the user equipment 1100.

The protector consent guide page may include information that requests protectors of infants to consent that user equipment receives or displays medical data of the infants.

As illustrated in FIG. 22, the display unit 1160 of the user equipment 1100 can display an object 1330 that requests a protector of an infant to consent to receive or display medical data of the infant. Further, the display unit 1160 of the user equipment 1100 can display an object 1340 for acquiring a password for a user equipment to receive or display medial data of an infant.

The user equipment 1100 can acquire protector consent information on the basis of user input for an object in a protector consent guide page displayed on the display unit 1160 of the user equipment 1100 (S440).

According to an embodiment of the present invention, the user equipment 1100 can transmit the acquired protector consent information to the service providing device 1200 (S450).

The service providing unit 1200 can acquire medical data according to the requester identification information on the basis of the acquired protector consent information (S460).

In detail, the service providing unit 1200 can compare the received protector consent information with predetermined security data, and it acquires medical data according to the requester identification information, when the received protector consent information and the predetermined security data are matched.

In this process, the service providing device 1200 can keep information (for example, user equipment phone number, MAC, and the like) about the user equipment transmitting the protector consent information.

The service providing device 1200 can transmit the medical data acquired in accordance with requester identification information to the user equipment (S470).

When an infant NFC tag is tagged to the user equipment 1100 in a hospital, the user equipment 1100 requests medical data of the infant in many cases. Accordingly, the medical data providing system according to the present invention can provide medical data to the user equipment 1100 in a simple way by determining whether it is required to acquire the medical data.

The user equipment 1100 can display the received medical data (S480).

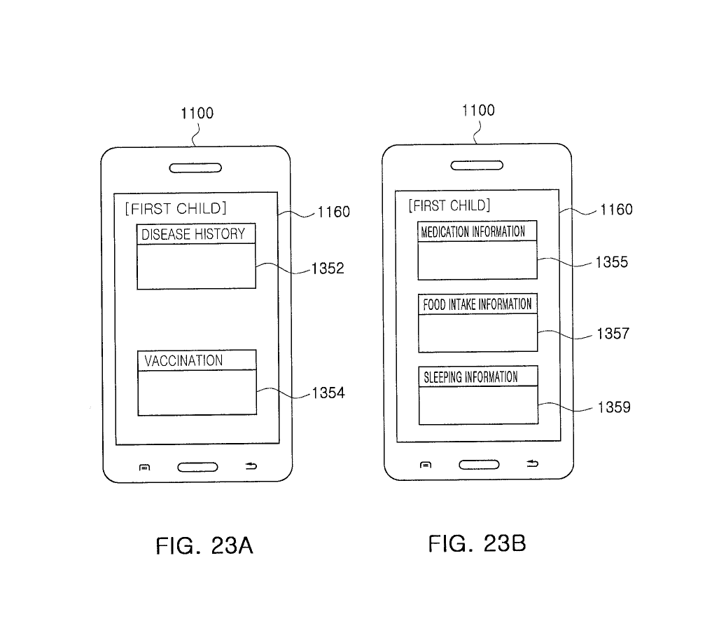

FIGS. 23A and 23B are diagrams illustrating an example of a way that a user equipment displays medical data of an infant.

FIG. 23A exhibits an example of a way that user equipment displays disease history information 1352 and vaccination history information 1354 of an identified infant.

FIG. 23B exhibits an example of a way that user equipment displays medication information 1355, food intake information 1357, and sleeping information 1359 of an identified infant. Herein, the medication information exhibits the information of medicines that an infant took. The food intake information exhibits the information about food that an infant took at predetermined time at predetermined dates. Further, the sleeping information is information about the time when an infant slept at predetermined time and predetermined dates.

When a doctor diagnoses an infant in a hospital, it is difficult to check the accurate condition of the infant through a protector. This is because infants recently spend most time in childcare institutions in many cases.

However, recently, various activities of infants in childcare institutions can be recorded on a server through electronic kindergartener notebooks for infants.

Accordingly, the service providing device 1200 according to an embodiment of the present invention can have infant data (disease history information, vaccination history information, medication information, food intake information, sleeping information, and the like) of infants and provide medical data of the infants.

Alternatively, the service providing device can acquire medication information, food intake information, and sleeping information from an external server (electronic kindergartener notebook service providing server).

Accordingly, the medical data providing system according to an embodiment of the present invention can allow infants to conveniently take medical examination and treatment, using the data recorded on an electronic kindergartener notebook for infants.

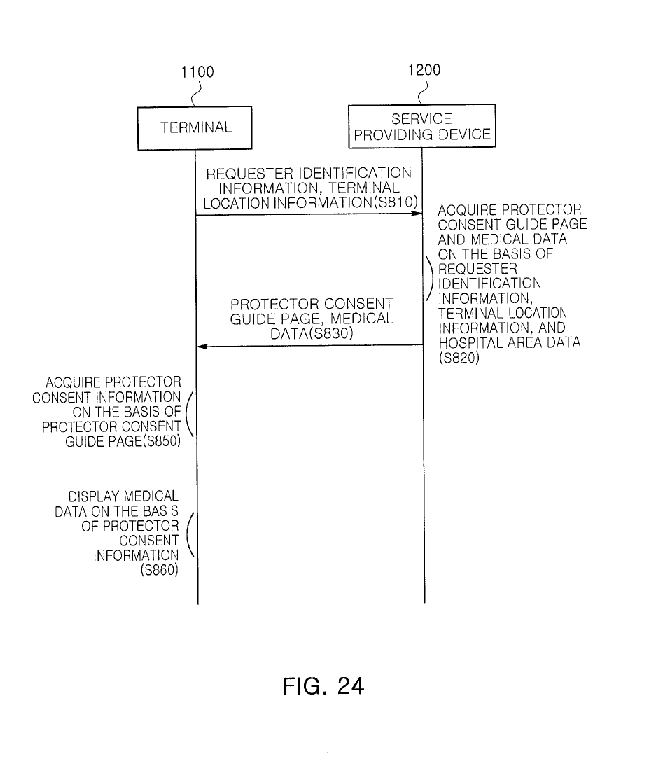

FIG. 24 is a signal flowchart illustrating a process of transmitting/receiving data according to a second embodiment in a medical data providing system of the preset invention.

As described above, the user equipment 1100 can acquire requester identification information. For example, the user equipment 1100 can acquire requester identification information through tagging with an infant NFC tag. Herein, the infant NFC tag may mean an NFC tag that an infant has. In this process, the user equipment 1100 can acquire user equipment location information.

Referring to FIG. 24, the user equipment 1100 can transmit the acquired requester identification information and user equipment location information to the service providing device 1200 (S810).

The service providing device 1200 can acquire a protector consent guide page corresponding to requester identification information and medical data on the basis of the received user equipment location information and the hospital area data (S420).

In this process, the medical data can be encoded.

According to an embodiment of the present invention, the service providing device 1200 can transmit the protector consent guide page and the encoded medical data (S830).

The user equipment 1100 can display the received protector consent guide page.

Further, the user equipment 1100 can acquire protector consent information on the basis of user input for an object in a protector consent guide page displayed on the display unit 1160 of the user equipment 1100 (S850).

In this process, the user equipment 1100 can display medical data according to requester identification information on the basis of the acquired protector consent information and predetermined security data in the medical data (S860).

In detail, the control unit of the user equipment 1100 can compare the acquired protector consent information with predetermined security data, and it can control the display unit to display medical data according to the requester identification information, when the acquired protector consent information and the predetermined security data are matched.

According to this embodiment, the process of transmitting data reduces, so communication efficiency and data processing speed can be improved.

A method of controlling user equipment and a service providing device according to an embodiment of the present invention can be recorded in a computer program, and codes and code segments of the computer program can be easily inferred by computer programmers in the field. The computer program is stored in computer readable media, and read and executed by a computer or user equipment and a service providing device according to an embodiment of the present invention, so a method of controlling the user equipment and the service providing device can be implemented.

The computer readable media include a magnetic recording medium, an optical recording medium, and a carrier wave medium. A computer program for achieving the method of controlling user equipment and a service providing device according to an embodiment of the present invention may be stored and installed in a built-in memory in the user equipment and the service providing device. Alternatively, an external memory such as a smart card in which a computer program for achieving the method of controlling user equipment and a service providing device according to an embodiment of the present invention is stored and installed may be mounted on the user equipment and the service providing device through an interface.

It should be understood that the present invention may be changed and modified by those skilled in the art without departing from the scope of the present invention. Accordingly, the embodiment described herein are provided not to limit, but to explain the spirit of the present invention and the spirit and the scope of the present invention are not limited by the embodiments. The protective range of the present invention should be construed on the basis of claims and all the technical spirits in the equivalent range should be construed as being included in the scope of the right of the present invention.

The present invention makes infants actively check their attending and leaving by arousing their interest in order to sense their attending/leaving through NFC tagging, lets their parents know it in real time, and outputs greeting messages set for each infant on the basis of attending/leaving management data for infants and medical data of infants, so it can be used in various fields including an infant management field and a database field.

Further, the present invention provides a user with a list of actually available hospitals in consideration of time to be taken to reach hospitals and to register in the hospitals and provides information about the closest hospital in the available hospitals, thereby improving convenience of used. Accordingly, it can be used in various fields including a childcare field, a medical field, and a marketing field.

Further, the present invention can acquire medical data by determining whether it is required to acquire medical data and allows infants to easily take medical examination and treatment using electronic kindergartener notebooks for infants, thereby improving convenience of use. Accordingly, it can be used in various fields including a childcare field, a medical field, and a marketing field.

What is claimed is:

1. User equipment comprising:
a tag information management unit that acquires infant identification information;
a photographing unit that acquires infant photograph information corresponding to the infant identification information;
a control unit that acquires attending/leaving management data on the basis of at least one of the infant identification information, the infant photograph information, and time information when the tag information management unit acquires the infant identification information, and that acquires a greeting message on the basis of the infant identification information; and an alarming unit that outputs the greeting message.

2. The user equipment of claim 1, wherein the control unit includes an attending/leaving management module that acquires the attending/leaving management data on the basis of at least one of the infant identification information, the infant photograph information, and the time information.

3. The user equipment of claim 2, wherein the control unit includes a medical data management module keeping infant medical data including at least one of disease history information, vaccination history information, medication information, food intake information, and sleeping information according to the infant identification information.

4. The user equipment of claim 3, wherein the control unit acquires a greeting message on the basis of at least one of the infant identification information, the attending/leaving management data, and the infant medical data.

5. The user equipment of claim 4, wherein the greeting message has at least one of a name period based on the infant identification information, a greeting period based on the attending/leaving management data, and an additional period based on the infant medical data.

6. The user equipment of claim 1, further comprising a communication unit that receives the infant identification information from an NFC reader in a terminal cradle.

7. The user equipment of claim 1, wherein the alarming unit includes at least one of a voice output module and a video output module.

8. A service providing device comprising;
a medical request data collecting unit that acquires medical request data from user equipment;
a control unit that acquires available hospital information on the basis of the medical request data and hospital data, and necessary time information of the available hospital information and acquires path data of at least one of hospitals included in the available hospital information on the basis of the necessary time information; and
a communication unit that transmits the path data to the user equipment.

9. The service providing device of claim 8, wherein the necessary time information includes movement time information and necessary registration time information of a hospital.

10. The service providing device of claim 8, wherein the medical request data includes at least one of date information, time information, requester identification information, user equipment location information, and symptom information, and
the hospital data includes at least one of working day information, working hour information, medical department information, and present state information of hospitals.

11. The service providing device of claim 10, wherein the control unit includes an available hospital collecting module that acquires available hospital information on the basis of symptom information included in the medical request data and medical department information included in the hospital data.

12. The service providing device of claim 11, wherein the available hospital collecting module acquires available hospital information on the basis of date information included in the medical request data and working day information included in the hospital data.

13. The service providing device of claim 12, wherein the control unit includes a necessary time calculation module that acquires movement time information of hospitals included in the available hospital information on the basis of traffic information and user equipment location information included in the medical request data.

14. The service providing device of claim 13, wherein the available hospital collecting module acquires available hospital information on the basis of the movement time information, necessary registration time information, and working hour information included in the hospital data, and
the control unit acquires path data of a hospital of which the necessary time is the shortest in movement time of hospitals included in the available hospital information.

15. The service providing device of claim 8, further comprising a medical data management unit including medical data that includes at least one of disease history information, vaccination history information, and attending physician information according to requester identification information.

16. A service providing device comprising:
a requester identification information management unit that acquires requester identification information from user equipment;
a user equipment location information management unit that acquires user equipment location information from the user equipment;
a guide page management unit that acquires a protector consent guide page on the basis of the requester identification information, the user equipment location information, and hospital area data and transmits the protector consent guide page to the user equipment; and
a medical data management unit that acquires medical data according to requester identification information on the basis of protector consent information based on the protector consent guide page and transmits the medical data to the user equipment.

17. The service providing device of claim 16, further comprising a storage unit that keeps at least one of hospital area data and medical data according to requester identification information,
wherein the medical data includes at least one of disease history information, vaccination history information, medication information, food intake information, and sleeping information.

18. The service providing device of claim 17, wherein the storage unit keeps requester identification information acquired from the user equipment.

19. The service providing device of claim 17, wherein the guide page management unit acquires a protector consent guide page, when the user equipment location information is in the hospital area.

20. The service providing device of claim 16, wherein the medical data management unit compares the protector consent information with predetermined security data, and acquires medical data according to requester identification information when the protector consent information and the predetermined security data are matched.
